(19) United States
(12) Patent Application Publication
(10) Pub. No.: US 2026/0098824 A1
(43) Pub. Date: Apr. 9, 2026

(54) A HIGH BRIGHTNESS PRIMARY X-RAY SOURCE FOR IN-LINE XPS AND XRF METROLOGY

(71) Applicant: NOVA MEASURING INSTRUMENTS INC., Fremont, CA (US)

(72) Inventors: Guorong V. ZHUANG, San Jose, CA (US); Bruno W. SCHUELER, San Jose, CA (US); Gildardo DELGADO, Livermore, CA (US)

(73) Assignee: NOVA MEASURING INSTRUMENTS INC., Fremont, CA (US)

(21) Appl. No.: 19/114,772

(22) PCT Filed: Sep. 22, 2023
(86) PCT No.: PCT/IB2023/059373

§ 371 Date: Mar. 24, 2025

Related U.S. Application Data
(60) Provisional application No. 63/376,770, filed on Sep. 22, 2022.

(51) Int. Cl. G01N 23/223; G01N 23/2206

(52) U.S. Cl. CPC G01N 23/223; G01N 23/2206

(57) ABSTRACT

A method for evaluating a sample, the method includes (a) illuminating a liquid metal jet alloyed with aluminum with an electron beam to provide a first x-ray beam; (b) spectral filtering, by a filtering unit, the first x-ray beam to provide a second x-ray beam; (c) illuminating a sample with the second x-ray beam; and (e) detecting x-ray radiation emitted from the sample as a result of the illuminating of the sample.

### CROSS REFERENCE

This application claims priority from U.S. provisional patent 63/376,770 filing date Sep. 22, 2022, which is incorporated herein by reference.

### BACKGROUND OF THE INVENTION

The most common x-ray energy utilized in XPS is AlKα (1486.7 eV) which is typically transported and focused onto a wafer surface via a monochromator in order to narrow the natural line width of the emission line for chemical state identification.

Photoelectrons generated by AlKα radiation will have a kinetic maximum energy of ˜1486 eV, thus limiting the analysis depth to ˜10 nm, as well as providing a limited range of secondary x-ray fluorescence lines which can be detected simultaneously and uses as independent input for the total dose of the analyzed material.

It is often desirable to increase the overall analysis depth by utilizing intense higher energy primary x-rays which in turn also widens the range of excited fluorescent x-ray lines.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a phase diagram;

FIG. 2 illustrates an example of a generation of a high brightness X-RAY beam;

FIG. 3 illustrates an example of a generation of a high brightness X-RAY beam;

FIG. 4 illustrates an example of a quasi-continuously tunable single wavelength x-ray source; and

FIG. 5 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electrooptic components known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system.

There is provided a system for evaluating a sample, the system includes (a) a source of a liquid metal jet alloyed with aluminum; (b) an electron beam source that is configured electron optics that is configured to illuminate the liquid metal jet alloyed with aluminum with an electron beam to provide a first x-ray beam; (c) a filtering unit that is configured to spectral filter the first x-ray beam to provide a second x-ray beam; (d) electron optics configured to illuminate a sample with the second x-ray beam; and (e) a detector that is configured to detect x-ray radiation emitted from the sample as a result of the illuminating of the sample.

There is provided a high brightness primary x-ray source for in-line XPS and XRF metrology capable of producing x-ray beams in the range of about 1keV and higher to enable wafer compositional analysis and thickness metrology with medium and high energy x-ray beams.

There is provided a X-ray source that may produce (for example simultaneously) high brightness Al Kα (hv=1486.7 eV) , as well as continuum high energy radiation generated from Al-alloy, such as Al—Ga, Al—In, or other low-melting point metal combinations.

The continuum radiation generated can also be selected in 2^{nd} order, 3rd order and 4^{th} order Bragg reflection at photon energies of 2973.4 eV, 4460.1 eV and 5946.8 eV, respectively, transported and focused by a focusing quartz monochromator, i.e., generation and selection of four or more distinct high brightness/high intensity x-ray energies which can be focused onto the wafer.

The 1^{st}, 2^{nd}, etc., order x-ray radiation for material compositional analysis on small target using combination of XPS and XRF, providing distinctly different and independent material information.

To increase the throughput while shrinking the measurement spot size as required for in-line XPS/XRF metrology, a high brightness X-ray source in combination of an efficient monochromator is required.

The bright x-ray source will provide smaller divergence angle and high flux concentrating on a smaller spot. It can also be leveraged to utilize a smaller size monochromator with reduced risk of crystal misalignment, as well as cost savings.

A smaller size monochromator will likely provide improved energy resolution, as well as spot size and is slightly less sensitive to minor alignment errors. Use of a monochromator will ascertain a final X-ray line width at the target of <0.5 eV energy width to obtain photoelectron energy resolution to resolve various bonding states of elements for excitation X-ray energies<1500 eV. Higher primary x-ray brightness permits use of a monochromator crystal populated area reduction by 2× and with an x-ray source has 10× higher x-ray flux, the overall upside is still 5× with upside in spot size and t-put.

Further, the availability of higher energy X-rays from higher Bragg diffraction orders X-ray will also be useful for tuning XPS and XRF photon energy to provide optimal excitation conditions for material characterization (composition, contamination, and thickness), depending on the thickness and composition of the material.

Excitation of the primary x-ray beams may be accomplished via:
a. An intense e-beam illuminating a Liquid, Solid, or Gas jet.
b. The electron beam source may be a focused conventional LaB6 electron source or equivalent.
c. The electron beam may be generated via a photocathode source illuminated by a focused light/laser source of suitable wavelength of high brightness instead of conventional electron sources.
d. Light assisted x-ray emission from the target in conjunction with an electron beam

The excitation of the primary source x-rays may also be accomplished by a focused high-intensity laser beam. The preferred excitation mode is continuous X-ray beam generation, though pulsed x-ray source operation could also be considered with appropriate orchestration of the metrology system.

There is provided an Al—Ga liquid metal alloy as X-ray target to generate high brightness Al Kα (1486.7 eV) and Ga (9251.67 eV).

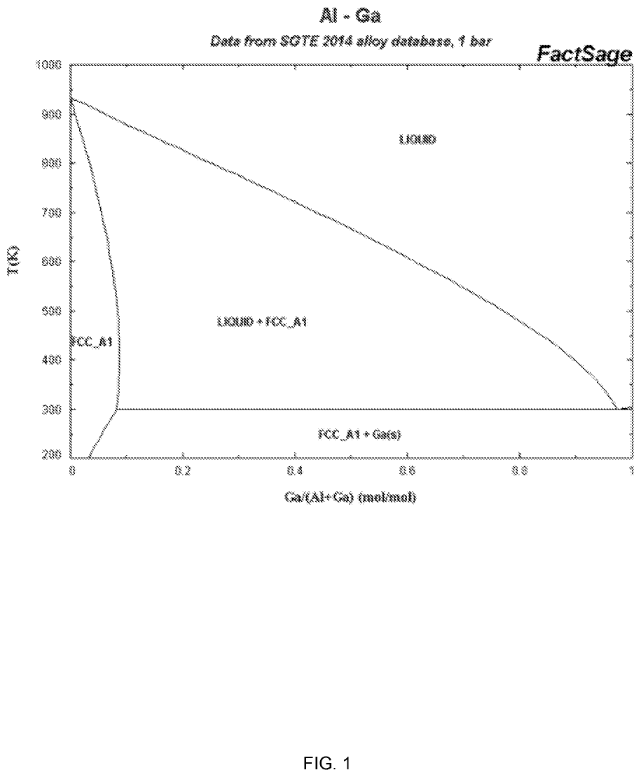

The Al—Ga alloy (refer to FIG. 1) phase diagram indicates that Al—Ga alloy is in liquid phase slightly above room temperature with various stoichiometry.

Interestingly, the Al—Ga liquid metal alloy was used as catalyst for splitting H2O to generate hydrogen and its properties were characterized (Y. Yu et al., Jeffrey T. Ziebarth et al.)

In mass ratio of AlₓGa₁₋ₓ (x=10, 20, 30, 40, 50) Al was evenly distributed in the liquid metal at above ambient temperature.

In liquid Al—Ga alloy, it was found the presence of Ga prevent the Al2O3 passivation layer formation, which is not the case for solid Al. However, for Al₇₀Ga₃₀, and Al₈₀Ga₂₀ the elements of Ga and Al are not evenly distributed and trace Al₂O₃ was detected. The X-ray brightness for Al Kα generated from the Al—Ga liquid metal jet (or other suitable liquid metal jet alloyed with Al) is estimated at least an order of magnitude higher than that of conventional solid target. Using monochromator to efficiently collect large solid angle from such source, the flux fall on measurement target is estimated to be 1˜2 order of magnitude higher than solid Al target in an analysis area of <˜50 μm ×50 μm.

Al—Ga alloy presents as liquid phase at elevate temperature, it can be used as X-ray target in jet form. A bright x-ray source of Al Kα and Ga Kα can thus be generated when high power high brightness electron beam is directed and impinged on fast moving liquid metal alloy jet.

The system may employ a liquid metal Al—Ga alloy as Xray source anode to generate high brightness Al Kα and Ga Kα for XPS and XRF combination system. The weight x, in AlxGa100−x, can be ranging from x<60 to x=0.

The bright X-ray source using Al—Ga alloy may be incorporated in a XPS and XRF in-line metrology system (as disclosed in U.S. Pat. No. 9,240,254 incorporated herein by reference) and used with monochromator to generate high brightness monochromatized Al Kα at 1486.7 eV and higher harmonic photon energy (2973.4 eV, 4460.1 eV and 5946.8 eV) up to 4^{th} order for high energy XPS and XRF application, along with Ga Kα at 9251.67 eV. Ga Kα can be used with a different monochromator to generate alternative high brightness monochromatized X-ray for material composition analysis using XPS or XRF, as well as XPS XRF combo method.

Al—Ga and Al—In alloy or other suitable metal alloy served as X-ray target, when excited by high energy and high brightness electron beam generated by photocathode, gives rise to characteristic Al Kα and In Kα lines and superimposed on a continuous x-ray spectrum, so called Bremsstrahlung background.

In general, Bremsstrahlung is produced most efficiently when high energy small particles interact with higher atomic number elements. Specifically, in the context of this disclosure, Bremsstrahlung radiation generation from In, Sn or Ga will be much higher than Al, and its yield is increase with electron energy and electron beam power. Due to the fast heat dissipation in LMJ target, the source can sustain significantly higher electron source energy and power, thus higher Bremsstrahlung. The Bremsstrahlung radiation may be selected by monochromator to provide higher energy X-rays suitable for XRF, as well as XPS at increased analysis depth.

The bright electron beam is a prerequisite condition, albeit not a guaranteed condition to generate high brightness X-ray beam emerging from the liquid metal jet.

A bright e-beam source coupling with liquid metal jet anode will enhance the X-ray performance. It is known to those in art that increase e-beam power input to X-ray anode will increase the X-ray intensity.

However, to generate high brightness X-ray, a high brightness electron source with high power density and high brightness needs to be paired with an anode target. Simply increasing the electron beam brightness and power density was known to yield catastrophic failure of the X-ray source with solid anode X-ray target. In liquid metal target case, due to the circulation and replenish nature of liquid metal jet, higher e-beam power and power density can be used to generate high brightness X-ray beams. The most common electron source used in X-ray source is consisting of LaB6 cathode and electron focusing optics.

However, an alternative method to generate high brightness and high-power density electron beam for high brightness Liquid metal jet x-ray source by using a laser driven photocathode for which the intrinsic emission spot size is determined by the size of the illuminating light source. (As disclosed in U.S. PA No. 63/365,414, incorporated herein by reference).

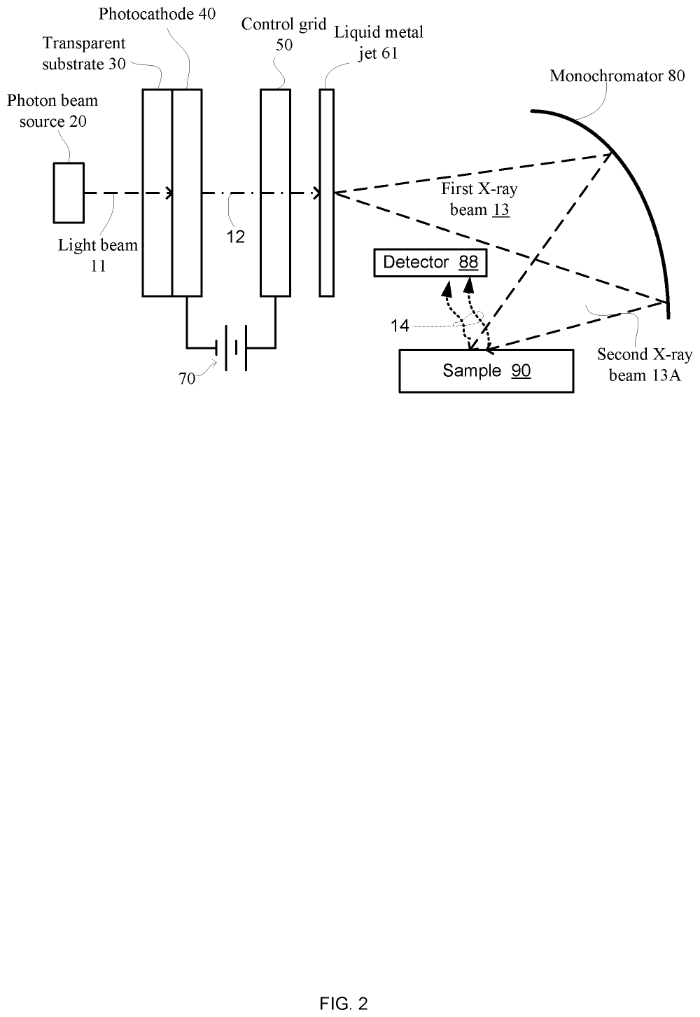

FIG. 2 illustrates a schematic of high brightness electron beam generated by photocathode operating in transmission mode to generate a first X-ray beam with anode material disclosed. Coupled to a monochromator, this first X-ray beam is converted to a second-x-ray beam that serves as an excitation source for XPS and XRF.

In FIG. 2 the transmissive x-ray source includes a radiation source such as photon beam source 20 such as but not limited to a laser that is configured to direct radiation (such as light beam 11) towards a transparent substrate 30 that mechanically supports a photocathode 40. The light beam 11 impinges on one side of the photocathode 40 and causes electrons to be emitted from an opposite side of the photocathode to form electron beam 12. Electron beam 12 is attracted to control grid 50 (that is biased by bias circuit 70 in relation to the photocathode 40, the bias may determine an energy of the electrons that are emitted from the control grid) and then passes through the liquid metal jet (LMJ) to provide first x-ray beam 13 that impinges on a monochromator 80 to provide second x-ray beam 13A that illuminates the sample 90, causing a generation of fluorescent x-rays 14 detectable by detector 88.

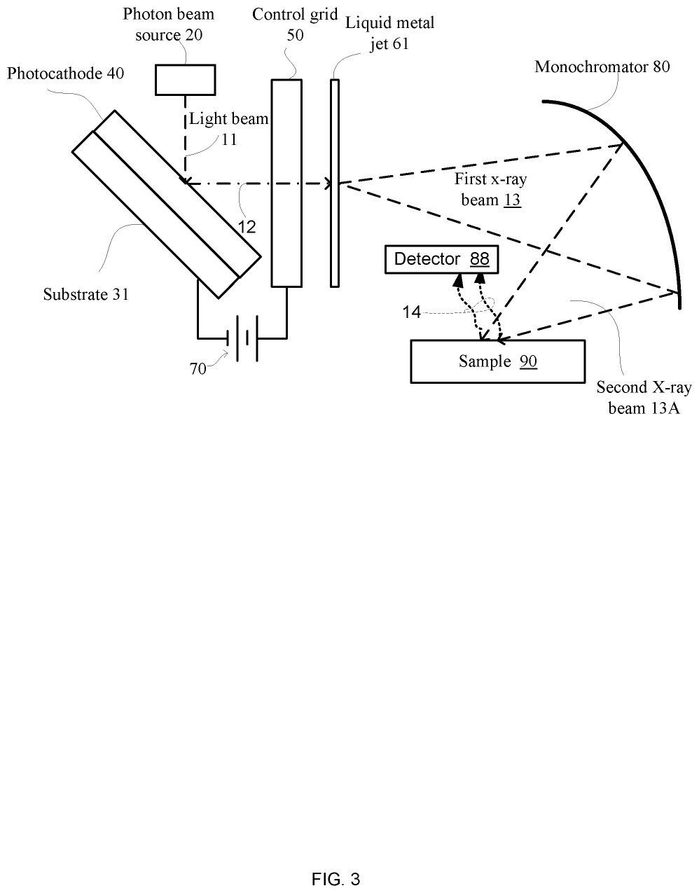

In FIG. 3 the transmissive x-ray source includes a radiation source such as photon beam source 20 such as but not limited to a laser that is configured to direct radiation (such as light beam 11) towards photocathode 40. The photocathode 40 is supported by substrate 31. The light beam 11 impinges a side of the photocathode 40 and causes electrons to be emitted from the same side to form electron beam 12. Electron beam 12 is attracted to control grid 50 (that is biased by bias circuit 70 in relation to the photocathode 40, the bias may determine an energy of the electrons that are emitted from the control grid) and then passes through the liquid metal jet (LMJ) to provide first x-ray beam 13 that impinges on a monochromator 80 to provide second x-ray beam 13A that illuminates the sample 90, causing aa generation of fluorescent x-rays 14 detectable by detector 88.

The x-ray source of FIG. 3 may be substituted with a gas chamber or liquid jet to provide a continuum x-ray spectrum across a broad x-ray energy range to provide the first x-ray beam 13A that impinges on a monochromator 80 to provide second x-ray beam 13A that illuminates the sample 90, causing a generation of fluorescent x-rays 14 detectable by detector 88.

In both FIGS. 2 and 3 the electron beam 12 is of high quality can also be shaped and focused to very small spot size by using electron beam optics (positioned between the photocathode and the x-ray material.

In both FIGS. 2 and 3 that may be provided an electron optics may include at least some components of an electron beam column, such as one or more apertures and/or one or more deflectors and/or one or more scan coils and/or one or more electromagnetic lenses and/or one or more magnetic lenses and/or one or more detectors.

In addition, any suitable X-ray optics and monochromator, e.g., an x-ray beam collimator combined with flat monochromator and subsequent focusing optics can also be used with the high brightness liquid metal jet source disclosed here. The emitted photoelectrons will be collected by focused electron lens and direct to energy analyzer in XPS, while fluorescent x-rays are also generated from the material and collected by EDS or WDS in XRF.

High brightness, high intensity continuum radiation generated from LMJ X-ray in combination with suitable non-dispersive x-ray focusing optics and x-ray energy selection via a movable (or tuning the angle) monochromator crystal can provide a quasi-continuously tunable single wavelength x-ray source for XPS and XRF at the analysis site. If a fixed crystal focusing monochromator is used for x-ray beam transport to the wafer, multiple distinct diffraction orders increasing energy can be transported and focused.

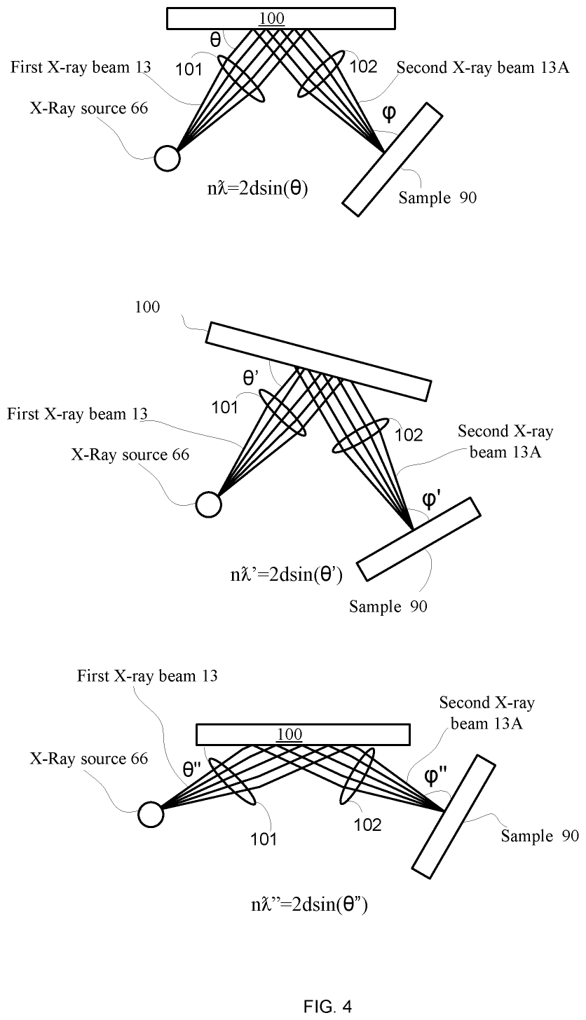

FIG. 4 is a schematic of quasi-continuously tunable single wavelength x-ray source, in which single wavelength turning is enabled by rotating flat monochromator 100, followed by adjusting two polycapillary or other suitable reflective achromatic collimating and focusing optics 101 and 102 to satisfy the Bragg condition.

The continuous X-ray wavelength turning is via crystal rotation with respect to incident X-ray, collimated by 1^{st} polycapillary or reflective optics, and the reflected rays satisfy Bragg angle of crystal monochromator be focused to sample as excitation source for XPS and XRF. A first x-ray beam 13 impinges on the crystal 100 and the crystal diffracts a second x-ray beam 13A that impinges on sample 90. The wavelength of the second x-ray beam follows the equation n/λ′=2d sin(θ′).

FIG. 4 also illustrates the quasi-continuously tunable single wavelength x-ray source, in which single wavelength turning is enabled by translating flat monochromator, followed by adjusting two polycapillary or reflective collimating and focusing optics to satisfy the Bragg condition. The single X-ray wavelength selection from broadband LMJ source is via crystal monochromator translation, followed by adjustment of 1st polycapillary (or reflective) optic and 2^{nd} polycapillary (or reflective) optic to satisfy the Bragg condition. The wavelength selection capability in combination with sample orientation as defined by single wavelength X-ray incident angle (φ and φ′) will provide great flexibility of sample probing depth in XPS and XRF.

The Al—Ga liquid metal anode when coupled with adequate bright electron beam source is estimated to yield at least an order of magnitude X-ray brightness than solid target anode X-ray source, according to our calculation using published scientific paper (Malte Wansleben et al., Journal of Analytical Atomic Spectrometry, 2019).

The system enables smaller measurement target capability in-line XPS (and XRF) without compromise signal to noise ratio and XPS energy resolution. Due to source brightness increase, signal contamination outside measurement spot will be suppressed, leading to more composition measurement accuracy and precision. In addition, the method would fully take advantages of a monochromator to transport and focus generated high energy X-rays via 2^{nd} and higher order Bragg reflection to the wafer. This in turn expands the in-line metrology application for XPS/XRF for different application use cases, i.e., expand extension of analysis depth for photoelectron escape, combined with an extended suite of fluorescent x-rays which can simultaneously be detected via XRF with the same tool.

Higher x-ray source brightness can be leveraged to use a smaller size monochromator with reduced risk for crystal misalignment, as well as cost savings. A smaller size monochromator will likely provide improved energy resolution, as well as spot size and is slightly less sensitive to minor alignment errors.

Furthermore, using a single X-ray source operating under different condition for XPS and XRF measurement—instead of two different X-ray sources is highly beneficial.

The high brightness X-ray source can generate Al Ka, Bremsstrahlung, as well as Ga Kα (or other suitable liquid jet material radiation) using the same electron beam power supply and the same x-ray source.

The suggested high brightness X-ray source provides access to continuously tunable or to several distinct multiples of the design wavelength (for example AlKα x-ray energy) offers the capability to:
a. Increase or decrease the analysis depth for XPS, and
b. Increase or decrease the number of characteristic fluorescent x-rays that are generated and available for detection.

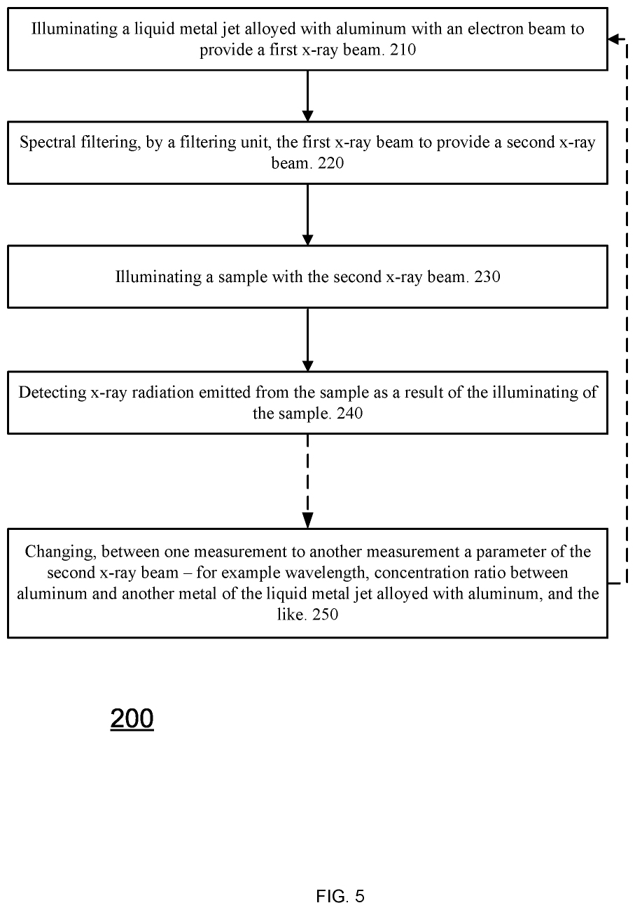

FIG. 5 illustrates an example of method 200 for evaluating a sample.

According to an embodiment, method 200 includes step 210 of illuminating a liquid metal jet alloyed with aluminum with an electron beam to provide a first x-ray beam.

According to an embodiment, step 210 is followed by step 220 of spectral filtering, by a filtering unit, the first x-ray beam to provide a second x-ray beam.

According to an embodiment, step 220 is followed by step 230 of illuminating a sample with the second x-ray beam.

According to an embodiment, step 230 is followed by step 240 of detecting x-ray radiation emitted from the sample as a result of the illuminating of the sample.

According to an embodiment, the electron beam is a continuous electron beam.

According to an embodiment, the method electron beam is a pulsed electron beam.

According to an embodiment, the second x-ray includes photoelectrons generated by AlKα radiation energy of about 1486 electron volts.

According to an embodiment, the second x-ray includes (i) a second order Bragg reflection of energy of about 2973.4 electron volts, (ii) a third order Bragg reflection of energy of about 4460.1 electron volts, and (iii) a fourth order Bragg reflection of energy about 5946.8 electron volts.

According to an embodiment, the second x-ray includes photoelectrons generated by GaLα radiation energy of about 1097.92 electron volts.

According to an embodiment, the second x-ray includes photoelectrons generated by GaKα radiation energy of about 9251.74 electron volts.

According to an embodiment, the liquid metal jet alloyed with the aluminum is an aluminum gallium alloy.

According to an embodiment, the liquid metal jet alloyed with the aluminum differs from an aluminum gallium alloy.

According to an embodiment, the method includes changing, between one measurement (at least one iteration of steps 210, 220, 230 and 240) to another measurement (at least one other iteration of steps 210, 220, 230 and 240), a parameter of the second x-ray beam-for example wavelength, changing a concentration ratio between aluminum and another metal of the liquid metal jet alloyed with aluminum, and the like. This is illustrates by step 250.

According to an embodiment, the method includes setting the second bandwidth by setting an angular relationship between the first x-ray beam and a crystal of a filtering unit.

According to an embodiment, the spectral filtering is executed by a monochromator.

According to an embodiment, the spectral filtering is executed by a crystal.

According to an embodiment, the spectral filtering is executed by single or multiple monochromators.

According to an embodiment, method includes performing a x-ray photoelectron spectroscopy (XPS) set of measurements, changing at least one parameter of the second x-ray beam, and performing an x-ray fluorescence (XRF) measurement set of measurements.

In the foregoing specification, the invention has been described with reference to specific examples of embodiments of the invention. It will, however, be evident that various modifications and changes may be made therein without departing from the broader spirit and scope of the invention as set forth in the appended claims.

Any reference to “comprising” or “Having” or “including” should be applied, mutatis mutandis to “consisting” and/or should be applied, mutatis mutandis to “consisting essentially of”.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

The described implementation of an alloyed Liquid Metal jet x-ray source may serve as an example for a broad band x-ray source but other x-ray sources providing a broad band continuum x-ray spectrum can be considered in conjunction with the invention. This may be an x-ray source using gas or liquid jets excited by and electron beam.

We claim:

1. A method for evaluating a sample, the method comprises:
a. illuminating a liquid metal jet alloyed with aluminum with an electron beam or a laser beam or a combination of laser beam and electron beam or multiple laser beams to provide a first x-ray beam;
b. spectral filtering, by a filtering unit, the first x-ray beam to provide a second x-ray beam;
c. illuminating a sample with the second x-ray beam; and
d. detecting x-ray radiation emitted from the sample as a result of the illuminating of the sample.

2. A method for evaluating a sample, the method comprises:
a. illuminating a gas or liquid jet or medium providing a broad energy range continuum of intense x-rays with an electron beam or a laser beam or a combination of laser beam and electron beam or multiple laser beams to provide a first x-ray beam;
b. spectral filtering, by a filtering unit, the first x-ray beam to provide a second x-ray beam;
c. illuminating a sample with the second x-ray beam; and
d. detecting x-ray radiation emitted from the sample as a result of the illuminating of the sample.

3. The method according to claim I wherein the electron beam is a continuous electron beam.

4. The method according to claim 1 wherein the electron beam is a pulsed electron beam.

5. The method according to claim 1 wherein the laser beam is a continuous laser beam.

6. The method according to claim 1 wherein the laser beam is a pulsed laser beam.

7. The method according to claim 1 wherein the laser beam have wavelength between 100 nm-5 um

8. The method according to claim 1 wherein the liquid metal jet target produces a broadband X-ray source ranging in X-ray Energy from 1 KeV-10 keV.

9. The method according to claim 1 wherein the second x-ray beam comprises photoelectrons generated by AlKα radiation energy of about 1486.7 electron volts.

10. The method according to claim 1, wherein the second x-ray beam comprises (i) a second order Bragg reflection of energy of about 2973.4 electron volts, (ii) a third order Bragg reflection of energy of about 4460.1 electron volts, and (iii) a fourth order Bragg reflection of energy about 5946.8 electron volts.

11. The method according to claim 1 wherein the second x-ray beam comprises photoelectrons generated by GaLα radiation energy—equivalent of about 1097.92 electron volts.

12. The method according to claim 1 wherein the second x-ray beam comprises photoelectrons generated by GaKα radiation energy—equivalent of about 9251.74 electron volts.

13. The method according to claim 1 wherein the liquid metal jet alloyed with the aluminum is an aluminum gallium alloy.

14. The method according to claim 1 wherein the liquid metal jet alloyed with the aluminum differs from an aluminum gallium alloy.

15. The method according to claim 1 comprising changing, between one measurement to another measurement, a concentration ratio between aluminum and another metal of the liquid metal jet alloyed with aluminum.

16. The method according to claim I comprising setting the second bandwidth by setting an angular relationship between the first x-ray beam and a crystal of a filtering unit.

17. The method according to claim 1 wherein the spectral filtering is executed by a monochromator.

18. The method according to claim 1 wherein the spectral filtering is executed by a crystal.

19. The method according to claim 1, wherein the spectral filtering is executed by single or multiple monochromators.

20. The method according to claim 1 comprising performing a x-ray photoelectron spectroscopy (XPS) set of measurements, changing at least one parameter of the second x-ray beam, and performing an x-ray fluorescence (XRF) measurement set of measurements.

21. A system for evaluating a sample, the system comprising:
a. a source of a liquid metal jet alloyed with aluminum;
b. an electron beam source that is configured electron optics that is configured to illuminate the liquid metal jet alloyed with aluminum with an electron beam to provide a first x-ray beam;
c. a filtering unit that is configured to spectral filter the first x-ray beam to provide a second x-ray beam;
d. electron optics configured to illuminate a sample with the second x-ray beam; and
e. a detector that is configured to detect x-ray radiation emitted from the sample as a result of the illuminating of the sample.

22. The system according to claim 21, wherein the second x-ray beam comprises photoelectrons generated by AlKα radiation energy of about 1486 electron volts.

23. The system according to claim 21, wherein the second x-ray beam comprises (i) a second order Bragg reflection of energy of about 2973.4 electron volts, (ii) a third order Bragg reflection of energy of about 4460.1 electron volts, and (iii) a fourth order Bragg reflection of energy about 5946.8 electron volts.

24. The system according to claim 21, wherein the second x-ray beam comprises photoelectrons generated by GaLα radiation energy of about 1097.92 electron volts.

25. The system according to claim 21, wherein the second x-ray beam comprises photoelectrons generated by GaKα radiation energy of about 9251.74 electron volts.

26. The system according to claim 21, wherein the liquid metal jet alloyed with the aluminum is an aluminum gallium alloy.

27. The system according to claim 21 wherein the liquid metal jet alloyed with the aluminum differs from an aluminum gallium alloy.
